(19) United States
(12) Patent Application Publication
(10) Pub. No.: US 2009/0179889 A1
(43) Pub. Date: Jul. 16, 2009

(54) PLASMA DISPLAY DEVICE AND METHOD OF DRIVING THE SAME

(76) Inventor: Hyuk-Jun Jang, Suwon-si (KR)

Correspondence Address: CHRISTIE, PARKER & HALE, LLP, PO BOX 7068, PASADENA, CA, 91109-7068, US

(21) Appl. No.: 12/345,517

(22) Filed: Dec. 29, 2008

(30) Foreign Application Priority Data
Jan. 15, 2008 (KR) 10-2008-0004408

(51) Int. Cl. G09G 5/00; G09G 3/28

(52) U.S. Cl. 345/212; 345/60

(57) ABSTRACT

A plasma display device and a method of driving the same are provided. A screen load ratio is calculated for each frame utilizing an input video signal. An address power consumption is calculated in an address period of each of a plurality of subfields of the frame utilizing the input video signal. A number of total sustain discharge pulses is set according to the screen load ratio and the address power consumption to display an image. In this fashion, power consumption and luminance may be more stably maintained.

### CROSS-REFERENCE TO RELATED APPLICATION

This application claims priority to and the benefit of Korean Patent Application No. 10-2008-0004408 filed in the Korean Intellectual Property Office on Jan. 15, 2008, the entire contents of which are incorporated herein by reference.

### BACKGROUND OF THE INVENTION

1. Field of the Invention

The present invention relates to a plasma display device and a method of driving the same.

2. Description of the Related Art

A plasma display device is a display device that uses a plasma display panel (“PDP”) that displays characters or images using plasma that is generated by a gas discharge. In the PDP, a plurality of cells are arranged in a matrix format. The plasma display device divides a frame into a plurality of subfields and drives the plurality of subfields to display an image.

The plasma display device divides a frame into a plurality of subfields, each having a different weight value, and drives the plurality of subfields. Each of the subfields includes an address period, a sustain period, and a reset period. In the address period, scan pulses are applied to a plurality of scan electrodes to select which cells will emit light and which cells will not emit light. In the sustain period, a high level voltage and a low level voltage of sustain discharge pulses are applied alternatively to the electrodes to perform sustain discharges in cells selected to emit light, in order to display an image. The reset period is utilized to reset the cells before scan pulses are applied in a subsequent address period.

During the sustain period, electric power that is consumed for applying sustain discharge pulses is controlled through an algorithm of automatic power control (“APC”). The APC decreases the number of sustain discharge pulses as an input screen load ratio increases, and increases the number of sustain discharge pulses as the input screen load ratio decreases. Accordingly, the plasma display device uniformly sustains power consumption.

However, generally, address power consumption is not considered in APC algorithms. That is, when a video signal having a high frequency of address switching is executed, address power consumption may be substantially greater than address power consumption for a video signal with a smaller amount of address switching. By controlling the number of sustain discharge pulses according to a screen load ratio without taking into account address power consumption, a power source unit may be overheated or damaged for video signals with higher frequencies of address switching.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a plasma display device and a method of driving the same, including a device and method of stably maintaining power consumption in a plasma display.

An embodiment of the present invention provides a method of driving a plasma display device by dividing a frame of an input video signal into a plurality of subfields, with each subfield having a corresponding weight value. The method includes: calculating a screen load ratio for the frame utilizing the input video signal; calculating an address power consumption generated in an address period of each of the plurality of subfields utilizing the input video signal; setting a number of total sustain discharge pulses according to the screen load ratio and the address power consumption; allocating the total sustain discharge pulses to the plurality of subfields according to a weight value assigned to each of the plurality of subfields; and displaying an image according to the number of the allocated sustain discharge pulses in each of the subfields.

Another embodiment of the present invention provides a method of driving a plasma display device by dividing a frame of an input video signal into a plurality of subfields, each subfield having a corresponding weight value. The method includes: calculating a screen load ratio for the frame using the input video signal; determining a first automatic power control level utilizing the screen load ratio; calculating an address power consumption generated in an address period of each of the plurality of subfields utilizing the input video signal; changing the first automatic power control level to a second automatic power control level according to the address power consumption; calculating a number of total sustain discharge pulses according to the second automatic power control level; allocating the total sustain discharge pulses to the plurality of subfields according to a weight value assigned to each of the plurality of subfields; and displaying an image according to the number of the allocated sustain discharge pulses in each of the subfields.

Yet another embodiment of the present invention provides a plasma display device. The plasma display device includes: a plasma display panel including a plurality of first electrodes, each of the first electrodes paired with a corresponding one of a plurality of second electrodes, a plurality of address electrodes crossing the plurality of first electrodes and the plurality of second electrodes, and a plurality of discharge cells defined by the plurality of first electrodes, the plurality of second electrodes, and the plurality of address electrodes; a controller for setting a number of total sustain discharge pulses using an input video signal; and a driver for driving the first to third electrodes according to a control signal generated by the controller. The controller is configured to calculate a screen load ratio for a frame utilizing the input video signal, to calculate address power consumption during an address period of each of a plurality of subfields of the frame, and to set the number of the total sustain discharge pulses according to the screen load ratio and the address power consumption.

According to these and other embodiment of the present invention, an APC level is determined according to a screen load ratio and an address power consumption. In this fashion, power consumption and luminance may be more stably maintained.

### BRIEF DESCRIPTION OF THE DRAWINGS

FIG. 1 is a diagram illustrating a plasma display device according to an exemplary embodiment of the present invention.

FIG. 2 is a block diagram of a controller according to an exemplary embodiment of the present invention.

FIG. 3 is a block diagram illustrating a configuration of an address APC unit according to an exemplary embodiment of the present invention.

FIG. 4 illustrates an APC table according to an exemplary embodiment of the present invention.

### DETAILED DESCRIPTION OF THE EMBODIMENTS

In the following detailed description, only certain exemplary embodiments of the present invention are shown and described, simply by way of illustration. As those skilled in the art will recognize, the described embodiments may be modified in various ways without departing from the spirit or scope of the present invention. Accordingly, the drawings and description are to be regarded as illustrative in nature, rather than restrictive. Like elements are denoted by like reference numerals throughout the specification.

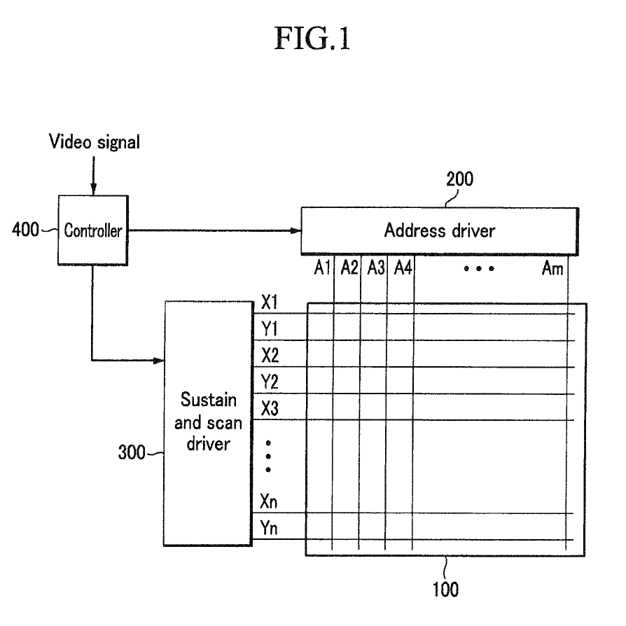

FIG. 1 is a diagram illustrating a plasma display device according to an embodiment of the present invention.

As shown in FIG. 1, the plasma display device includes a plasma panel 100, an address driver 200, a sustain and scan driver 300, and a controller 400.

The plasma panel 100 includes a plurality of address electrodes (“A electrodes”) A1-Am extending in a vertical direction, a plurality of sustain electrodes (“X electrodes”) X1-Xn and a plurality of scan electrodes (“Y electrodes”) Y1-Yn extending in a horizontal direction. The X electrodes and the Y electrodes are arranged in pairs, with each X electrode, for example X1, positioned adjacent a corresponding Y electrode, for example Y1. The address driver 200 receives an address driving control signal from the controller 400 and applies a display data signal to each of the A electrodes A1-Am during each address period to select which cells will emit light during a subsequent sustain period. The sustain and scan driver 300 receives control signals from the controller 400 and alternately inputs sustain discharge voltages to the Y electrodes Y1-Yn and the X electrodes X1-Xn to perform sustain discharges in the selected cells.

The controller 400 receives a frame of an external video signal including R, G, and B video signals and synchronization signals, divides the frame into a plurality of subfields, and divides each subfield into a reset period, an address period, and a sustain discharge period (“sustain period”)The controller 400 adjusts the number of sustain discharge pulses during the sustain period of each subfield of a frame, and sends control signals accordingly to the address driver 200 and the sustain and scan driver 300.

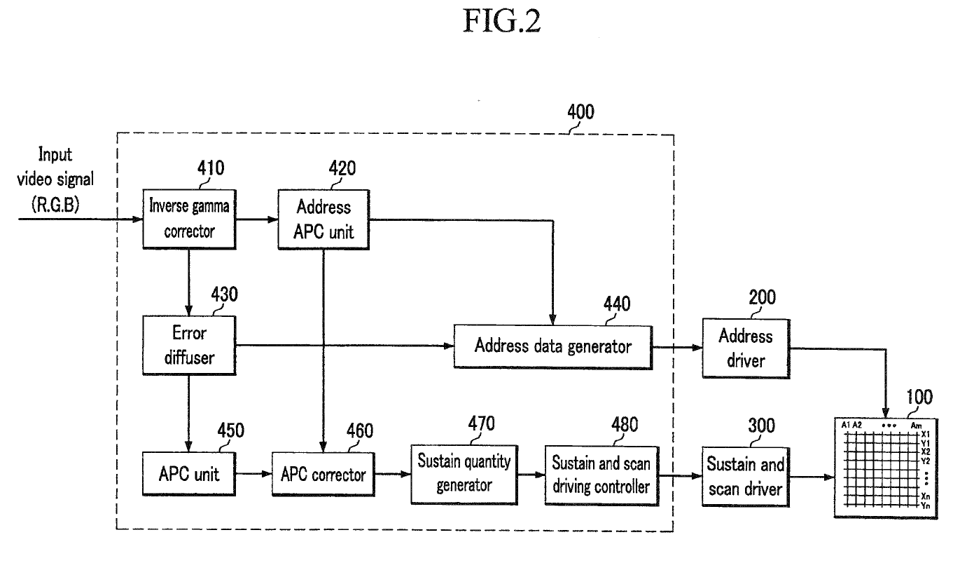

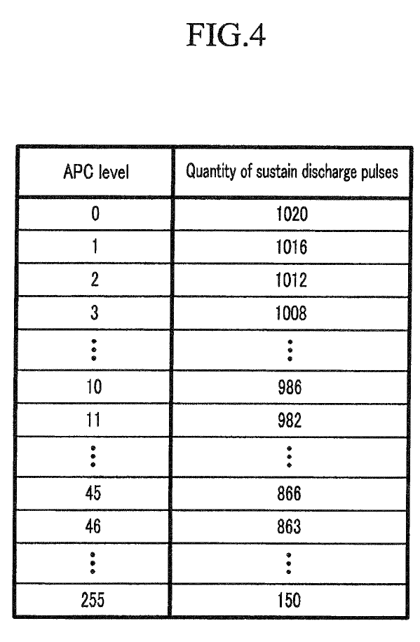

A controller 400 of the plasma display device according to an embodiment of the present invention is described hereinafter in detail with reference to FIGS. 2 to 4. FIG. 4 illustrates an example of an automatic power control lookup table according to an exemplary embodiment of the present invention.

FIG. 2 is a block diagram of a controller in an exemplary embodiment of the present invention.

As shown in FIG. 2, the controller 400 includes an inverse gamma corrector 410, an address APC unit 420, an error diffuser 430, an address data generator (or subfield data generator) 440, an APC unit 450, an APC corrector 460, a sustain quantity generator 470, and a sustain and scan driving controller 480.

The inverse gamma corrector 410 maps input data of an n bit R, G, and B image to an inverse gamma curve, and corrects the image input data to an m bit video signal, where m is generally greater than or equal to n. In a general plasma display device, n may have a value of, for example, 8, while m may have a value of, for example, 10 or 12.

In this case, the inverse gamma corrector 410 is configured to process a digital video signal (i.e., the input video signal). When an analog video signal is input to the plasma display device, an analog to digital converter may precede the inverse gamma corrector 410 to convert the analog video signal to a digital video signal. The inverse gamma corrector 410 may include a lookup table which stores data corresponding to an inverse gamma curve for mapping a video signal, or alternatively, a logic circuit, for generating data corresponding to an inverse gamma curve using a logic operation.

The address APC unit 420 (i.e., an address automatic power controller) determines whether address power consumption is high or low using output data of the inverse gamma corrector 410. If address power consumption is high (e.g., above a predefined threshold), the address APC unit 420 outputs an APC level change value for correcting an APC level to the APC corrector 460. If address power consumption is low (e.g., not above the threshold), the address APC unit 420 may not output an APC level change value to the APC corrector 460, or may output an APC level change value of 0. In some embodiments, in low address power consumption situations, the address APC unit 420 may further output a control signal for adjusting address data to the address data generator 440. The address APC unit 420 determines whether or not data of a frame has high address power consumption through an analysis of on/off states of cells in each subfield. The address APC unit 420 determines the number of on/off state changes between adjacent cells in a vertical or column direction along each of the A electrodes A1 through Am. Specifically, address power consumption indicates electric power that is expended when switching pulses on and off to the plurality of address electrodes during an address period in order to select which cells will emit light and which cells will not emit light during a subsequent sustain period.

The error diffuser 430 error-diffuses extended bits of a low-order m-n bit image in which inverse gamma correction is performed by the inverse gamma corrector 410 to surrounding pixels, and displays the image. Error diffusion is a method of displaying a low-order bit of an image by separating the low-order bit of an image to diffuse an error and extending the image to adjacent pixels, and can be easily understood by a person of ordinary skill in the art so a detailed description thereof is omitted.

The address data generator 440 generates subfield data in accordance with image data output from the error diffuser 430. The address data generator 440 may also receive a control signal from the address APC unit 420 for adjusting the subfield data. The address data generator 440 rearranges the subfield data into data readable by the address driver 200 for driving the address electrodes of the plasma display device, generates an address control signal for controlling the address driver 200, and outputs the address control signal to the address driver 220.

The APC unit 450 detects a screen load ratio from image data output by the error diffuser 430 and calculates a first APC level according to the detected screen load ratio. The APC unit 450 outputs the calculated first APC level to the APC corrector 460.

In this case, a screen load ratio may be calculated with an average signal level (“ASL”) of a video signal that is input for a frame, as represented by Equation 1.

$$ASL = ( {\sum }_{V} {R}_{n} + {\sum }_{V} {G}_{n} + {\sum }_{V} {B}_{n} ) / 3 N \qquad Equation 1$$

Here, Rₙ, Gₙ, and Bₙ are gray levels of R, G, and B image data, respectively, V is a frame, and 3N is data quantity of R, G, and B image data that are input for the frame.

When an APC level change value is input from the address APC unit 420 using, for example, the APC table that is shown in FIG. 4, the APC corrector 460 corrects the first APC level to a second APC level to correspond to the APC level change value. Specifically, the APC corrector 460 increases the first APC level by an APC level change value. Accordingly, as the number of sustain discharge pulses decreases according to the APC level change value, increased address power consumption may be compensated for by the decrease in the number of sustain discharge pulses. The APC corrector 460 outputs the number of sustain discharge pulses according to the second APC level to the sustain quantity generator (or sustain number generator) 470.

The sustain quantity generator 470 allocates the number of sustain discharge pulses to each subfield using information of the number of sustain discharge pulses allocated by the APC corrector 460.

The sustain and scan driving controller 480 generates a control signal corresponding to the number of sustain discharge pulses that are output from the sustain quantity generator 470 and outputs the control signal to the sustain and scan driver 300. In this case, the sustain quantity generator 470 and the sustain and scan driving controller 480 are individually described, however both may be simultaneously embodied within one block.

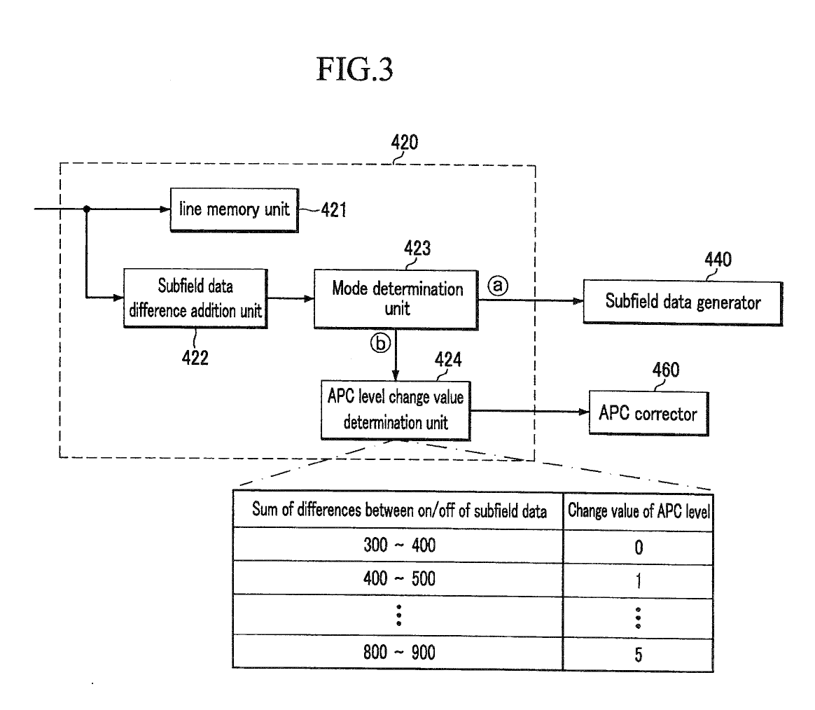

FIG. 3 is a block diagram illustrating a configuration of an address APC unit 420 according to an exemplary embodiment of the present invention.

As shown in FIG. 3, the address APC unit 420 includes a line memory unit 421, a subfield data difference addition unit 422, a mode determination unit 423, and an APC level change value determination unit 424.

The subfield data difference addition unit 422 of the address APC unit 420 analyzes the difference between subfield data of adjacent upper and lower cells in each column using data in which an input video signal is converted to cell-by-cell on/off data for each subfield. In some embodiments, a front end of the subfield data difference addition unit 422 may include a data processor. That is, the data processor converts the input video signal to cell-by-cell on/off data on a subfield basis. When it is assumed that the PDP divides a length of a sustain period of a frame into eight subfields (1SF-8SF) each having a weight value of 1, 2, 4, 6,16, 32, 64, and 128 and drives the subfields in order to express 256 gray levels, the data processor converts a video signal of, for example, a gray level 100 to 8 bit data of “00100110”. In “00100110”, each “0” and “1” sequentially correspond to eight subfields (1SF-8SF), and a “0” represents that a cell or dot does not discharge, or remains off, in a corresponding subfield, while a “1” represents that a cell or dot discharges, or turns on, in a corresponding subfield.

The subfield data difference addition unit 422 adds differences between subfield data values of adjacent upper and lower cells in each column from a video signal that is converted to on/off data on a subfield basis. That is, the subfield data difference addition unit 422 summates the number of times each A electrode is switched on and off during a particular address period to select and set adjacent discharging cells. The subfield data difference addition unit 422 then adds the sums of each subfield of a frame. Because the act of switching an A electrode on and off consumes a given amount of power, the subfield data difference addition unit 422 may calculate the sum of the on/off state changes between the adjacent discharge cells in each column within a subfield, as represented by Equation 2.

$$AP = {\sum }_{i = 1}^{n - 1} {\sum }_{j = 1}^{m} ( \vert {R}_{ij} - {R}_{( i + 1 ) j} \vert + \vert {G}_{ij} - {G}_{( i + 1 ) j} \vert + \vert {B}_{ij} - {B}_{( i + 1 ) j} \vert ) \qquad Equation 2$$

Here, Rᵢⱼ, Gᵢⱼ, and Bᵢⱼ are on/off data of R (red), G (green), and B (blue) discharge cells of an i-row and a j-column. In this case, the subfield data difference addition unit 422 obtains a value of each subfield using Equation 2 and adds values of each subfield in all subfields constituting a frame. Equation 2 represents the sum of subfield data differences for each subfield and it may be determined whether address power consumption is large or small through the sum of subfield data differences in each subfield, as in Equation 2. It may thus be determined whether address power consumption is large or small by adding all values that are obtained by Equation 2 in all subfields.

In general, because a video signal is input in series in a column order, in order to calculate the difference between on/off data of two adjacent discharge cells and to store a video signal of one row, the line memory unit 421 is used, as shown in FIG. 3. When on/off data for a video signal of one row is input through the line memory unit 421, the cell-by-cell on/off data is sequentially stored, and the subfield data difference addition unit 422 reads a previous row of data stored in the line memory unit 421 to calculate the difference between the on/off data on a subfield basis in two vertically adjacent discharge cells. Further, the address APC unit 420 may calculate the difference between the on/off data on a subfield basis in two discharge cells having an XOR (exclusive OR) operation of the on/off data. Here, the sum of the differences between on/off states of the subfield data indicates the number of times of address switching. Therefore, as the sum of the differences between on/off states of the subfield data increases, the frequency of address switching also increases, and consequently, address power consumption increases.

The mode determination unit 423 determines whether the sum of the differences between on/off states of adjacent cells in a particular subfield is above a threshold value. If the sum is above a threshold value, the mode determination unit 423 determines that a video signal in which inverse gamma correction is performed is in a special mode that consumes a large amount of address power. If the sum is less than a threshold value, the mode determination unit 423 determines that a video signal in which inverse gamma correction is performed is in a normal mode that consumes a relatively lower amount of address power. When it is determined that a video signal in which inverse gamma correction is performed is in a normal mode (a direction \textcircled{a} in FIG. 3), the mode determination unit 423 may output a control signal for controlling or adjusting address data to the address, or subfield, data generator 440. In contrast, when it is determined that a video signal in which inverse gamma correction is performed is in a special mode (a direction \textcircled{b} in FIG. 3), the mode determination unit 423 outputs a signal for notifying that the video signal is in a special mode to the APC level change value determination unit 424.

The APC level change value determination unit 424 determines an APC level change value corresponding to the sum of the differences between on/off states of vertically adjacent cells in a particular subfield. In this case, the APC level change value determination unit 424 determines and outputs an APC level change value when the sum is greater than a threshold value with reference to a lookup table. The APC level change configuration described herein is an example, and it will become apparent to a person of ordinary skill in the art that the value may be changed.

Here, the APC level change value is proportional to the sum of the differences between on/off states of vertically adjacent cells in a subfield. As the sum increases, the APC level change value increases. However, when the APC level abruptly changes, the number of sustain discharge pulses may also change abruptly, which may cause a flicker phenomenon. Therefore, in an exemplary embodiment of the present invention, an APC level change value according to the sum of the differences between on/off states of adjacent cells in a subfield is set within a range which will not cause a flicker phenomenon.

In general, limiting address power consumption involves controlling address data. That is, after inverse gamma correction of an input image is performed, by controlling a process of generating address data, the frequency of switching of the address electrodes is reduced. While controlling address data may limit address power consumption, this is generally executed independent of controlling sustain discharge pulses, possibly deteriorating luminance of a display image. In an embodiment of the present invention, as a method of compensating for address power consumption, an APC level is corrected in addition to, or in lieu of, controlling address data in certain situations. By correcting an APC level according to address power consumption, the frequency of sustain discharge pulses are adjusted based on address electrode switching, and power consumption and luminance may be more stably maintained.

While this invention has been described with respect to particular embodiments, it is to be understood that the invention is not limited to the disclosed embodiments, but is instead intended to cover various modifications and equivalent arrangements included within the spirit and scope of the appended claims and their equivalents.

What is claimed is:

1. A method of driving a plasma display device by dividing a frame of an input video signal into a plurality of subfields, each subfield having a corresponding weight value, the method comprising:
calculating a screen load ratio for the frame utilizing the input video signal;
calculating an address power consumption generated in an address period of each of the plurality of subfields utilizing the input video signal;
setting a number of total sustain discharge pulses according to the screen load ratio and the address power consumption;
allocating the total sustain discharge pulses to the plurality of subfields according to a weight value assigned to each of the plurality of subfields; and
displaying an image according to the number of the allocated sustain discharge pulses in each of the subfields.

2. The method of claim 1, wherein setting a number of total sustain discharge pulses comprises:
setting the number of total sustain discharge pulses to a first number for a first frame having a first address power consumption; and
setting the number of total sustain discharge pulses to a second number that is smaller than the first number for a second frame having the same screen load ratio as the first frame and a second address power consumption that is higher than the first address power consumption.

3. The method of claim 1, wherein setting a number of total sustain discharge pulses comprises:
setting the number of total sustain discharge pulses to a first number for a first frame having a first screen load ratio; and
setting the number of total sustain discharge pulses to a second number that is smaller than the first number for a second frame having the same address power consumption as the first frame and a second screen load ratio that is higher than the first screen load ratio.

4. The method of claim 1, wherein the plasma display device comprises a plurality of first electrodes, each of the plurality of first electrodes paired with a corresponding one of a plurality of second electrodes, a plurality of address electrodes crossing the plurality of first electrodes and the plurality of second electrodes, and a plurality of discharge cells defined by the plurality of first electrodes, the plurality of second electrodes, and the plurality of address electrodes,
wherein the address power consumption is electric power consumed during the address period by switching pulses applied to the plurality of address electrodes on and off to select which of the plurality of cells will emit light for each of the plurality of subfields.

5. The method of claim 4, wherein calculating an address power consumption comprises:
converting the input video signal to subfield data corresponding to the plurality of subfields;
calculating a subfield address power consumption for each of the plurality of subfields by summating the number of on/off state changes between adjacent discharge cells in an address electrode direction for the plurality of discharge cells in each subfield; and
calculating the address power consumption by summating the subfield address power consumptions.

6. The method of claim 1, wherein the screen load ratio is calculated with an average signal level of an input video signal for a frame.

7. A method of driving a plasma display device by dividing a frame of an input video signal into a plurality of subfields, each subfield having a corresponding weight value, comprising:
calculating a screen load ratio for the frame utilizing the input video signal;
determining a first automatic power control level utilizing the screen load ratio;
calculating an address power consumption generated in an address period of each of the plurality of subfields utilizing the input video signal;
changing the first automatic power control level to a second automatic power control level according to the address power consumption;
calculating a number of total sustain discharge pulses according to the second automatic power control level;
allocating the total sustain discharge pulses to the plurality of subfields according to a weight value assigned to each of the plurality of subfields; and
displaying an image according to the number of the allocated sustain discharge pulses in each of the subfields.

8. The method of claim 7, wherein calculating an address power consumption comprises:
converting the input video signal to subfield data corresponding to a plurality of subfields;
calculating a subfield address power consumption for each of the plurality of subfields by adding the number of on/off state changes between adjacent discharge cells in a vertical direction for each subfield in the plurality of discharge cells; and
calculating the address power consumption by adding the subfield address power consumptions.

9. The method of claim 8, wherein the second automatic power control level is greater than the first automatic power control level;
wherein the number of total sustain discharge pulses decreases based on the second automatic power control level; and
wherein a greater difference between the first automatic power control level and the second automatic power control level creates a greater decrease in the number of total sustain discharge pulses.

10. A plasma display device comprising:
a plasma display panel comprising a plurality of first electrodes, each of the plurality of first electrodes paired with a corresponding one of a plurality of second electrodes, a plurality of address electrodes crossing the plurality of first electrodes and the plurality of second electrodes, and a plurality of discharge cells defined by the plurality of first electrodes, the plurality of second electrodes, and the plurality of address electrodes;
a controller for setting a number of total sustain discharge pulses using an input video signal; and
a driver for driving the first electrodes, the second electrodes, and the address electrodes according to a control signal generated by the controller,
wherein the controller is configured to calculate a screen load ratio for a frame utilizing the input video signal, to calculate address power consumption during an address period of each of a plurality of subfields of the frame, and to set the number of total sustain discharge pulses according to the screen load ratio and the address power consumption.

11. The plasma display device of claim 10, wherein the controller is further configured to set the number of total sustain discharge pulses to a first number for a first frame with a first address power consumption, and to set the number of total sustain discharge pulses to a second number that is smaller than the first number for a second frame with the same screen load ratio as the first frame and a second address power consumption higher than the first address power consumption.

12. The plasma display device of claim 10, wherein the controller is further configured to set the number of total sustain discharge pulses to a first number for a first frame that has a first screen load ratio, and to set the number of total sustain discharge pulses to a second number that is smaller than the first number for a second frame with the same address power consumption as the first frame and a second screen load ratio greater than the first screen load ratio.

13. The plasma display device of claim 10, wherein the address power consumption is electric power consumed during the address period of each of the subfields by switching pulses applied to the plurality of address electrodes on and off to select which of the plurality of discharge cells emit light for each of the plurality of subfields.

14. The plasma display device of claim 13, wherein the controller is further configured to convert the video signal to subfield data corresponding to a plurality of subfields, to calculate a subfield address power consumption for each of the plurality of subfields by summating the number of on/off state changes between adjacent discharge cells in an address electrode direction for the plurality of discharge cells in each subfield, and to calculate the address power consumption by summating the subfield address power consumptions.

15. The plasma display device of claim 10, wherein the screen load ratio is calculated with an average signal level of an input video signal for a frame.
